(19) United States
(12) Patent Application Publication
(10) Pub. No.: US 2005/0253557 A1
(43) Pub. Date: Nov. 17, 2005

(54) Electric charging system

(75) Inventor: Pei-Chih Yao, Taipei (TW)

Correspondence Address: BACON & THOMAS, PLLC, 625 SLATERS LANE, FOURTH FLOOR, ALEXANDRIA, VA, 22314, US

(73) Assignee: GRAND POWER SOURCES INC., TAIPEI (TW)

(21) Appl. No.: 10/845,148

(22) Filed: May 14, 2004

(51) Int. Cl. H02J 7/00

(52) U.S. Cl. 320/128

(57) ABSTRACT

The present invention discloses an electric charging system which comprises an electric charging power supply device and a voltage power supply device; wherein the voltage power supply device has a differential programmable IC, and the electric charging power supply device has more than one rechargeable battery with capacitors and Zener diodes connected in parallel, so that the time variable DC power voltage can be evenly distributed to each capacitor by the differential programmable IC. A limit current device is used to control the passing current for the charging. And the Zener diode connected in parallel can assure the chargeable battery and the capacitor operating in a safe loading condition of voltage.

### BACKGROUND OF THE INVENTION

1. Field of the Invention

The present invention relates to an electric charging system, more particularly to an electric charging system comprising more than one rechargeable battery connected in series or in parallel and a capacitor connected in series with each rechargeable battery, such that each capacitor can regulate the electric charging status of the rechargeable battery connected in series, and thus achieving the local electric equilibrium of each rechargeable battery to evenly charge each rechargeable battery; and a limit current device used to control the passing current for the electric charging, so that when the battery is discharged, the capacitor connected in series can stand a large power discharge at the initial stage of the electric discharge, and thus extending the life of the rechargeable battery.

2. Description of the Related Art

In general, a charging system charges several rechargeable batteries by connecting the rechargeable batteries in series or in parallel or in connected in series first and then in parallel later.

The method of connecting the rechargeable batteries in parallel will charge all rechargeable batteries with the same charging current. Therefore, when the charging system starts charging the batteries, it cannot fully charge all batteries if some batteries have some remained electric power capacity in the battery or adopt different types of resistors in the battery. The rechargeable battery with large remained electric power capacity or small internal resistance will be overcharged, and the one with small remained electric power capacity or large internal resistance cannot be fully charged.

Connecting several rechargeable batteries in parallel with a power supply cannot evenly distribute the electric current for charging all rechargeable batteries. For example, the current flowing in a rechargeable battery with a small internal resistance is larger than the current flowing in a rechargeable battery with a large internal resistance, and thus unable to evenly distribute the electric current to fully charge all rechargeable batteries with an ideal condition. The charging system will charge the rechargeable batteries one by one, and will timely adjust the charging of rechargeable batteries until all the rechargeable batteries are fully charged. Therefore, it increases the cost even it can fully charge every rechargeable battery.

### SUMMARY OF THE INVENTION

In view of the above-mentioned shortcomings, the inventor of the present invention developed and invented a charging system in accordance with the present invention.

The primary objective of the present invention is to provide a charging system, which comprises an electric charging power device and a power supply device and a voltage power supply device; wherein the voltage power supply device has a differential programmable IC, and the electric charging power supply device has more than one rechargeable battery connected in series or in parallel, and these rechargeable batteries have capacitors and Zener diodes connected in parallel, so that the time variable DC power voltage can be evenly distributed to each capacitor by the differential programmable IC and each capacitor connected in parallel with the rechargeable battery, and the electric charging status of the rechargeable battery connected in parallel can be adjusted by each capacitor according to the settings of DC voltage waveforms to achieve a local electric equilibrium for each rechargeable battery and evenly charge each rechargeable battery. A limit current device is used to control the passing current for the charging, so that when the battery is discharged, each capacitor connected in parallel with the rechargeable battery can stand a large electric power discharge at the initial status of the discharge, and the Zener diode connected in parallel can assure the rechargeable battery and capacitor operating in a safe loading condition of voltage, and thus enhancing the life of each rechargeable battery.

Another objective of the present invention is to provide an electric charging system, which comprises a power resistor connected to a Zener diode of its voltage power supply device in series for dividing the voltage and consuming the power.

### BRIEF DESCRIPTION OF THE DRAWINGS

FIG. 1 is a schematic circuit diagram of a first preferred embodiment of the present invention.

FIG. 2 is a schematic circuit diagram of a second preferred embodiment of the present invention.

FIG. 3 is a schematic circuit diagram of the programmable voltage power supply circuit according to a first preferred embodiment of the present invention.

FIG. 4 is a schematic circuit diagram of the programmable voltage power supply circuit according to a second preferred embodiment of the present invention.

FIG. 5 is a schematic circuit diagram of the programmable voltage power supply circuit according to a third preferred embodiment of the present invention.

FIG. 6 is a schematic circuit block diagram of the programmable voltage power supply circuit according to a third preferred embodiment of the present invention.

FIG. 7 is a schematic circuit diagram of the programmable voltage power supply circuit according to a third preferred embodiment of the present invention.

### DETAILED DESCRIPTION OF THE DRAWINGS

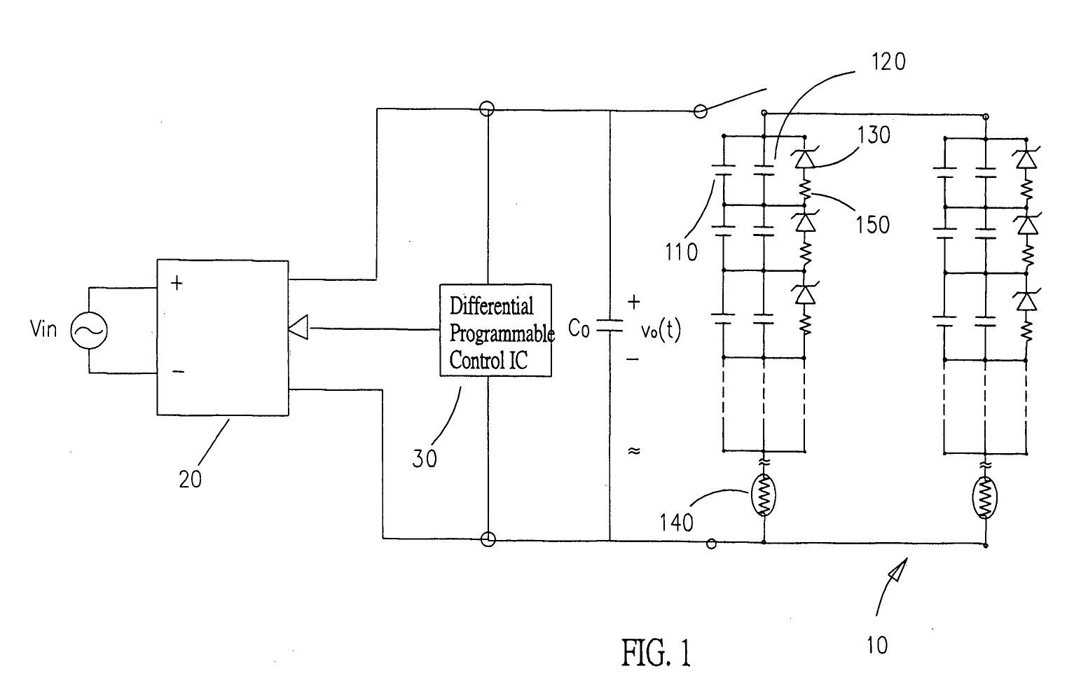

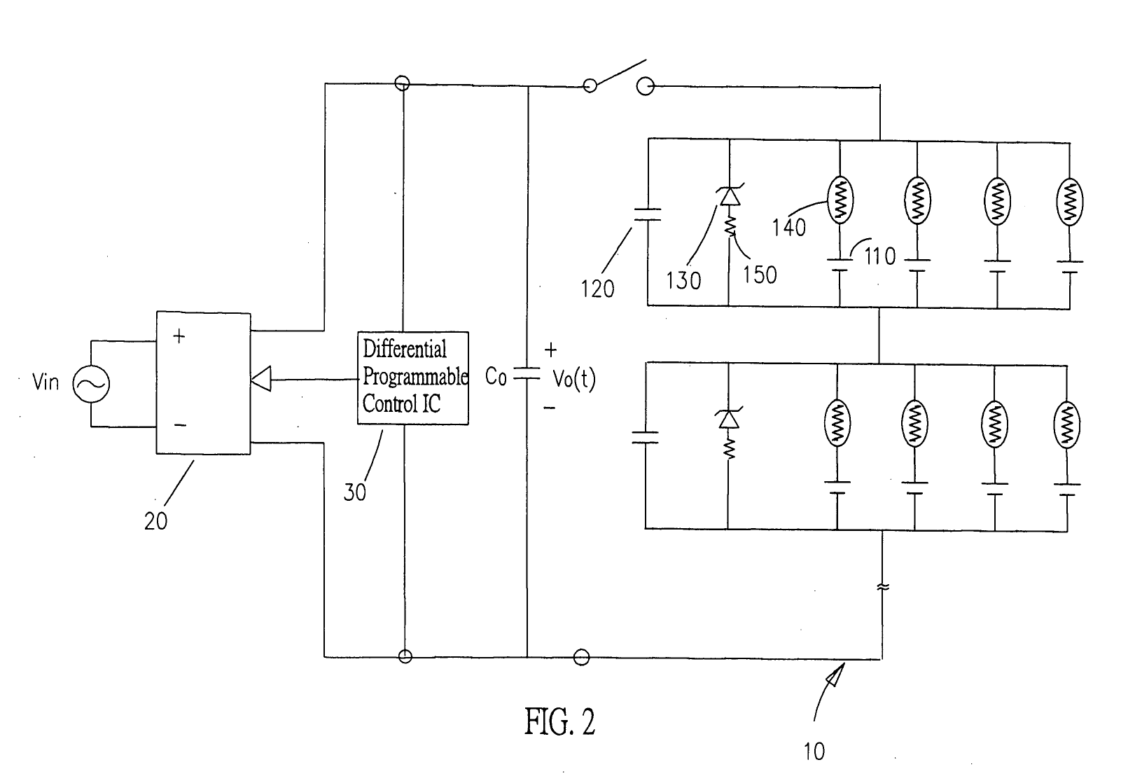

Please refer to FIGS. 1 and 2. The present invention discloses an electric charging system comprises a voltage power supply device 20 and a rechargeable power supply device 10; wherein the voltage power supply device 20 supplies the electric power required by the rechargeable power supply device 10, and a differential programmable IC 30 is disposed on the rechargeable power supply 20, so that an output from a DC current output end is compared with a preset voltage/time V(t) waveform by the comparison function of the differential programmable IC 30, and provides a stable voltage output as preset in a programmable control, and the rechargeable power supply device comprises at least one rechargeable battery 110. Such rechargeable batteries 110 are connected in series or in parallel, and the chargeable batteries 110 individually couples to a capacitor 120 and a Zener diode 130. The capacitor 120 and the Zener diode 130 are connected with each chargeable battery 110 in parallel. Further, the Zener diodes 130 individually comprise a power resistor 150 connected in series, and the power resistor 150 is used for dividing the voltage and consuming the power.

Please refer to FIG. 1 for a first preferred embodiment of the present invention. After the power is rectified and controlled by the voltage power supply device, a time variable DC current will pass into the rechargeable power supply device 10, and the rechargeable power supply device 10 comprises at least one rechargeable power supply device 10 connected in series with a rechargeable battery 110, and the rechargeable batteries 110 are individually connected to a capacitor 120 and a Zener diode 130 in parallel, and the rechargeable batteries 10 connected in parallel are connected to a limit current circuit 140 in series, so that the rechargeable batteries 110 are connected with each other in series by the foregoing connecting method.

Further, please refer to FIG. 2 for a second preferred embodiment of the present invention. After the power supply is rectified by the voltage power supply device and controlled by the different programmable IC 30, a time variable DC current will pass into the rechargeable power supply device 10, and the rechargeable power supply device 10 comprises at least one rechargeable power supply device 10 connected in parallel with a rechargeable battery 110, and the rechargeable batteries 110 are individually connected to a capacitor 120 and a Zener diode 130 in parallel, and the rechargeable batteries 110 connected in parallel are connected to a limit current circuit 140 in parallel, so that the rechargeable batteries 110 are connected with each other in parallel by the foregoing connecting method.

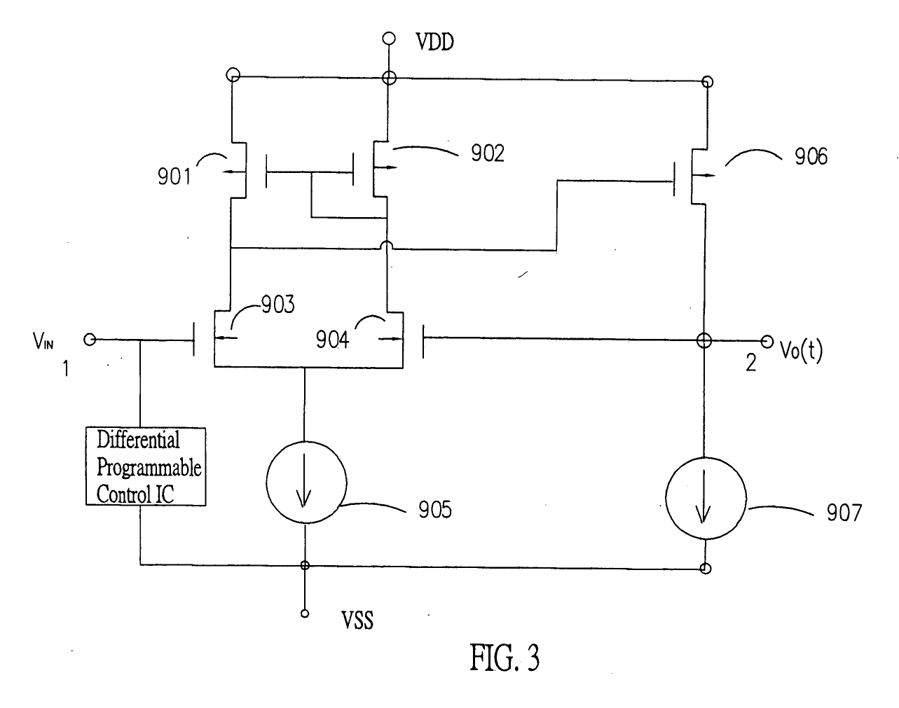

Please refer to FIG. 3. The voltage power supply device 20 is a feedback power supply device, which makes the N-channel MOS transistor 903, 904 into a differential coupler and connects to an end of a power supply 905 after its source is jointly connected, and its gates are connected to an input end 1 and an output end 2 respectively. The drain of a P-channel MOS transistor 901 (which is a transistor on the side of a current output of a power circuit) is connected to a high potential power supply VDD, and its gates connected to the gate and drain of the P-channel MOS transistor 902 and to the rain of the P-channel MOS transistor 902 after the gates are jointly connected. An output of differential couple is inputted to the P-channel MOS transistor 906 from the gate, and its source is connected to a high potential power supply VDD and the drain is connected to a connecting point of the output end 2 and the power supply 907. When the inputted or outputted voltage is larger or smaller than the programmable voltage V(t) produced by the voltage waveform programmable generator, the P-channel MOS transistor 906 is used for the charge and discharge and adjust the output voltage equal to the input voltage in a high speed.

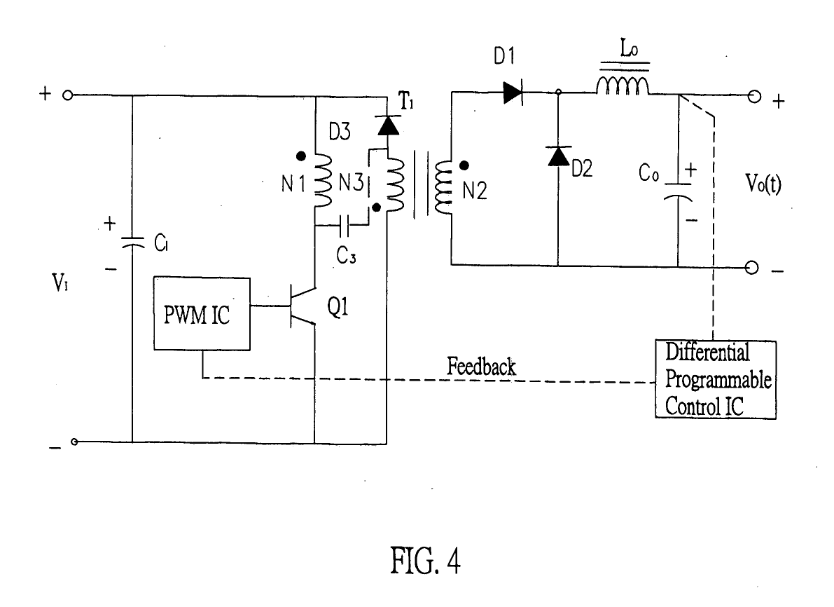

Please refer to FIG. 4. The voltage power supply device 20 is a forward power supply device, and such device comprises a capacitor Ci connected to the input end of the power supply for filtering. The capacitor Ci is connected in parallel with a transformer Ti having an elementary, a secondary, and a reciprocal coils (N1, N2, N3), and the elementary coil N1 of the transformer TI is connected in series with a power switch transistor Q1, and the polarity of the transistor Q1 are coupled to a pulse width modulate (PWM IC) and a driver circuit, and a capacitor C3 is disposed between the elementary coil N1 and the reciprocal coil N3, and a diode D3 is passed between the reciprocal coil N3 and a capacitor Ci, so that when the PWM IC and the driver circuit electrically connect the transistor Q1, the inputted power supply voltage will be supplied to the elementary coil N1 and forward to the secondary coil N2, and then sent to a loading end through the diode D1 and the inducer L₀. In the meantime, the diode D2 is in the reverse bias voltage condition; when the transistor Q1 is intercepted, the voltage polarities of the coil on the transformer T1 are reversed, so that the diode D2 is changed into a reverse bias voltage and become electrically disconnected, but the diode D3 is electrically connected. Then the energy of the loading end is supplied by the energies stored in L₀ and C₀. In the meantime, the condition of a bias voltage in the reverse direction of the transistor Q1 is controlled via the reciprocal coil N3. Similarly, the PWM IC is used to control the voltage output without following the original voltage change control function set for the charging.

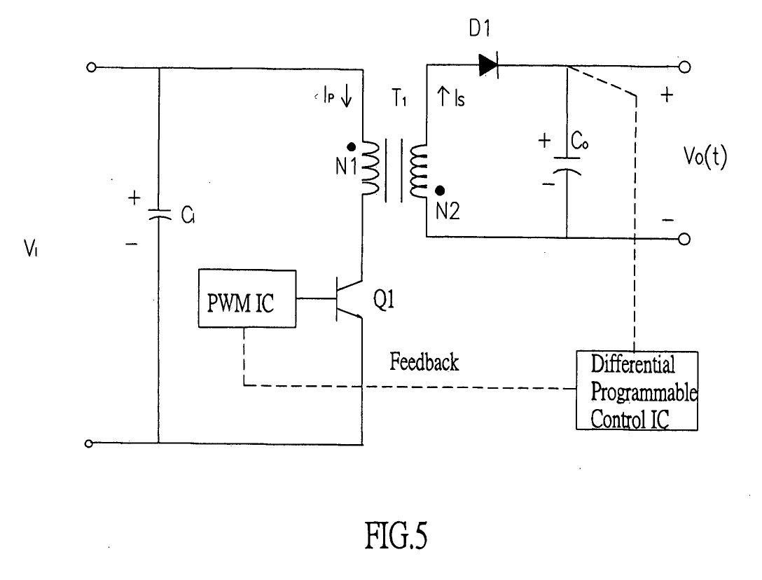

Please refer to FIG. 5. The voltage power supply device is a flyback power supply device, and comprises a capacitor Ci coupled to a power supply input end, and the capacitor Ci is connected in parallel with a transformer Ti having an elementary and a secondary coils (N1, N2), and the elementary coil N1 of the transformer T1 is connected in series with a transistor Q1, and the basic polarities of the transistor Q1 are coupled with a PWM IC and a driver circuit. Further, the secondary coil N2 is coupled individually to a diode D1 and a capacitor C₀, so that when it is in use, since the transformer concurrently acts as an output f stored energy capacitor, and the Ci is used for adjusting the power factor of the power supply. Further, since the power stage comprised of the PWM IC, the transistor Q1, and the transformer T1 is electrically connected by the control of an electronic switch of the transistor Q1. With the diode D1 of the secondary coil N2 and the capacitor C₀, a DC voltage output is obtained. However, when the transistor Q1 is electrically connected, the elementary coil N1 of the transformer T1 will have elementary current passing through.

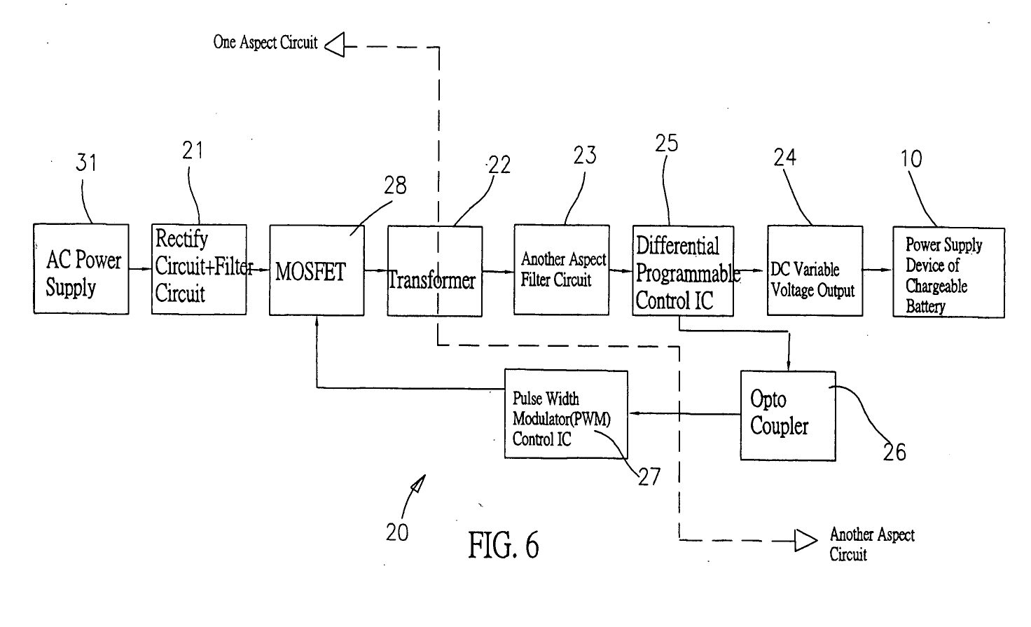

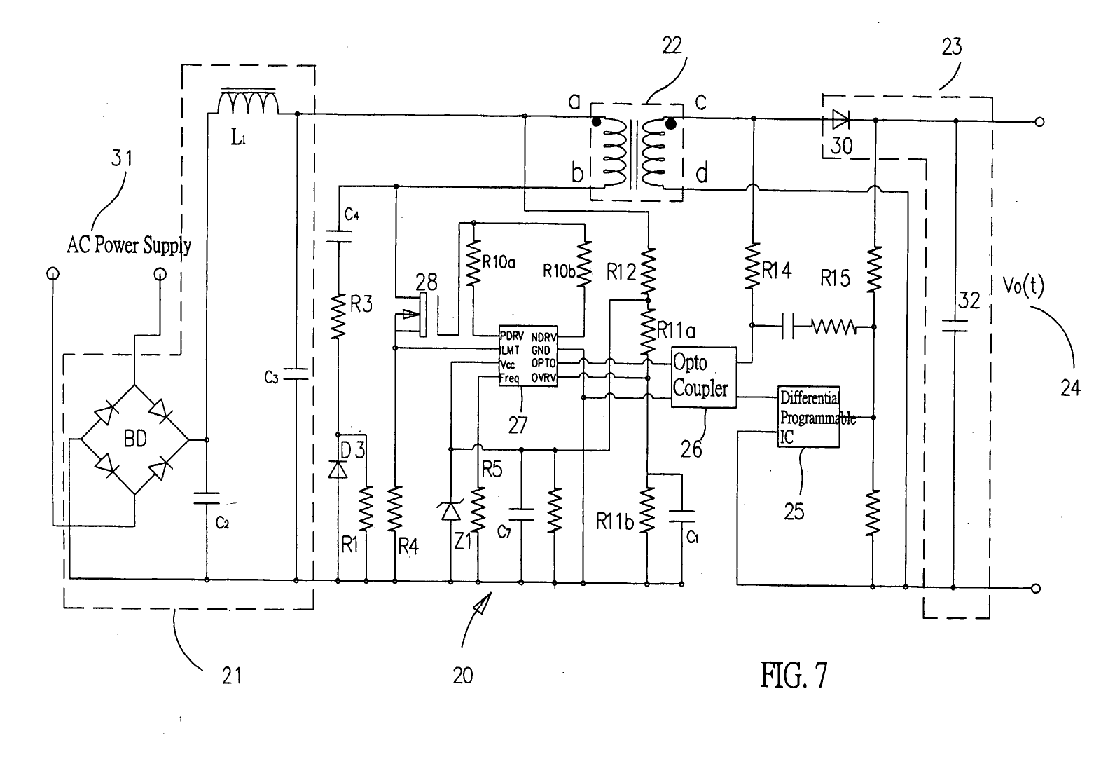

Please refer to FIGS. 6 and 7, the voltage power supply device 20 is a programmable power supply device, and the device comprises a rectify/filter circuit 21, a transformer 22, a secondary filter circuit 23, and a DC variable voltage V(t) output end 24; wherein the rectify/filter circuit 21 is connected to an AC power supply 31 and uses its capacitors C2, C3, inducer L1, and bridge diode (BD) to constitute a complete rectify/filter circuit for rectifying and filtering the AC power supply 31 to obtain a more stable DC power supply, and the transformer 22 is connected to the rectify/filter circuit 21. After the AC power supply 31 is rectified and filtered, the programmable switch circuit lowers the voltage by adjusting the AC voltage. The programmable control DC voltage is outputted from the DC voltage output end 24 after the secondary filter of the secondary filter circuit 23.

Further, please refer to FIGS. 6 and 7. An opto coupler 26 is disposed between the DC output end 24 of the power supply device 20 and the secondary filter circuit 23, and the opto coupler 26 is used for partition. The signal of the preset reference time variable voltage V(t) after being compared by the differential programmable IC controls the loading cycle of the PWM IC by the opto coupler 26, so that the output voltage V₀ is equal to the reference time variable voltage V(t).

Please refer to FIGS. 6 and 7 for the present invention. An end a of an elementary side of the transformer 22 is connected to a positive end at the rear of the rectify/filter circuit 21, and a negative end after the rectification is connected to the common ground end.

Please refer to FIGS. 6 and 7 for the present invention. An end b of an elementary side of the transformer 22 is connected to a drain of the metal oxide semiconductor field effect transistor (MOSFET) and the MOSFET is mainly sued to intercept the wave of the DC voltage.

Please refer to FIGS. 6 and 7 again. The secondary side of the transformer 22 is connected to the secondary filter circuit 23, and the secondary filter circuit comprises a diode 30 and a filter capacitor 32.

Please refer to FIG. 6. The driving electric power of the PWM IC 27 is supplied by the rectify/filter circuit 21 by stepping down the voltage and stabilizing the voltage circuit resistor R12, capacitor C₇ and Zener diode Z1, so that the voltage Vcc of the driving electric power of the PWM IC 27 is kept constant.

Please refer to FIGS. 6 and 7 again. The frequency of the PWM IC 27 is kept constant by the resistor R5.

Please refer to FIGS. 6 and 7. The pass voltage protection for the inputted AC voltage is controlled by connecting the voltage at the contact point of the resistors R11a, R11b to the OVRV of the PWM IC 27, so that when there is an over voltage OVRV and the AC power supply 31 is too high and exceeds the set value, the OVRV turns off the MOSFET 28 to protect the power supply device 20.

Please refer to FIGS. 6 and 7 again. The PDRV and NDRV of the PWM IC 27 control the rising and dropping slope of the ON and OFF voltage waveforms by the resistors R10a, R10b, and output the signal of the PWM modulator 27 to a gate of the MOSFET 28, so that the current passing through the soured to the drain and the elementary side of the transformer 22 is controlled by the gate voltage signal.

Please refer to FIGS. 6 and 7. The current passing through the MOSFET passes through the resistor R4 to produce a bias voltage inputted into a current detection end ILMT of the PWM IC 27. The preset allowable voltage drives the PWM IC 27 to produce an over current protection function to prevent the MOSFET 28 and the transformer 22 from being overloaded with electric currents.

Please refer to FIGS. 1 to 6. After the voltage power supply device is modulated by the differential control IC 25, the time variable DC power supply voltage is inputted into the rechargeable power supply device 10, each capacitor 120 connected in parallel to the rechargeable batteries 110 evenly distribute the voltage to each capacitor 120, and the DC voltage waveform set by each capacitor 120 is used to modulate the charging condition of the chargeable batteries 110 connected in parallel, and thus achieving the local electric equilibrium of the chargeable battery 110, so that each chargeable battery 110 can be charged evenly. During the discharge, each capacitor 120 connected in parallel to the rechargeable battery 110 can stand a large power discharge at the initial stage of the discharge. The Zener diode 130 connected in parallel can assure the rechargeable battery and capacitor to discharge in a safe loading voltage. In addition, a limit current circuit 140 can assure the current of the serially connected battery is kept in a normal rated range, and the over current of the rechargeable battery can be controlled.

In summation of the above description, the electric charging system according to the present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. An electric charging system, comprising:
a voltage power supply device, for supplying power supply to an electric charge circuit during an electric charge, said voltage power supply device comprising a differential programmable IC; and
a charging power supply device, having at least one rechargeable battery coupled to said charging power supply device, and said rechargeable batteries respectively coupled to a capacitor and a Zener diode;
thereby, in an electric charging, a voltage for charging being evenly distributed to each capacitor according to a predetermined programmable and timing by said differential programmable IC and said capacitor connected in parallel with said rechargeable battery; the waveform of a DC voltage set by each rechargeable battery being used to regulate the charging status of said rechargeable battery connected in parallel and achieve a local electric equilibrium for said each rechargeable battery and evenly charging said each rechargeable battery;
and a limit current device controlling a passing current, such that said each capacitor connected in parallel with said rechargeable battery being capable of standing a large power discharge at an initial stage of said electric discharge, and said Zener diode assuring said rechargeable battery and said capacitor to be operated in a safe loading condition of voltage.

2. The electric charging system of claim 1, wherein said rechargeable batteries are connected in series.

3. The electric charging system of claim 1, wherein said rechargeable batteries are connected in parallel.

4. The electric charging system of claim 1, wherein said rechargeable batteries is connected to a limit current device in series.

5. The electric charging system of claim 1, wherein said Zener diode is connected to a power resistor.

6. The electric charging system of claim 1, wherein said voltage power device is a feedback power supply circuit, for defining a N-channel MOS transistor as a differential couple, and its source being coupled to an end of a power supply after being jointly coupled, and its gates being coupled to an input end and an output end respectively; a source of a P-channel MOS transistor being coupled to a high potential source VDD, and its gates being coupled to a gate, a source, and a drain of said P-channel MOS transistor after said gate being jointly coupled; an output of a differential couple being inputted to said P-channel MOS transistor, and its source being coupled to a high potential power supply VDD, and its drain being coupled to a connecting point of said output end and said power supply; thereby if said input is not equal to said output, said P-channel MOS transistor is used selectively for a charge and a discharge to regulate an output voltage to be equal to an input voltage with a high speed.

7. The electric charging system of claim 1, wherein said voltage power supply device is a forward power supply device comprising a capacitor Ci coupled to a power supply input end for filtering, and said capacitor Ci is connected in parallel with a transformer T1 with an elementary, a secondary, and a reciprocal coils (N1, N2, N3), and said elementary coil N1 is connected with a power switch transistor Q1 in series, and the polarities of said transistor Q1 are coupled with a pulse width modulate IC and a driver circuit, and said elementary coil N1 and said reciprocal coil N3 have a capacitor C₃, and said reciprocal coil N3 and said capacitor Ci are connected to a diode D3 in series, and said secondary coil N2 is connected to a diode D1 and an inductor Lₒ respectively.

8. The electric charging system of claim 1, wherein said voltage power supply device is a flyback power supply device comprising a capacitor Ci coupled to a power supply input end and said capacitor Ci is connected in series with a transformer T1 with an elementary and a secondary coils (N1, N2), and said elementary coil N1 is connected with a transistor Q1 in series, and the polarities of said transistor Q1 are coupled with a pulse width modulate IC and a driver circuit, and said secondary coil N2 is connected to a diode D1 and a capacitor C₀, so that said transformer concurrently acts as an output for power storage inductor, and said capacitor Ci is used for adjusting the power factor of said power supply device, and a power stage comprised of a PWM, a transistor Q1, and a transformer T1 controls the electric connection of a switch for controlling said transistor Q1 by said pulse width modulate IC and operating with said diode D1 and capacitor C₀ of said secondary coil N2 to obtain a DC voltage output.

9. The electric charging system of claim 1, wherein said voltage power supply device is a programmable power supply device comprising a rectify/filter circuit, a transformer, a secondary filter circuit, and a DC output end, wherein said rectify/filter circuit is coupled to an AC power supply and uses its capacitors C2, C2 and its inductor L1 and bridge diode to constitute a whole rectify/filter circuit for rectifying and filtering said AC power supply to obtain a stable DC power supply, and said transformer is coupled to said rectify/filter circuit to rectify and filter said current, and then a programmable switch circuit lowers the voltage by adjusting an AC power supply, and then outputs said DC current from said DC output end through a secondary filter by said secondary filter circuit.
